(19) United States
(12) Patent Application Publication
(10) Pub. No.: US 2007/0196798 A1
(43) Pub. Date: Aug. 23, 2007

(54) Self-improvement system and method

(75) Inventors: Robert J. Pryor, Encinitas, CA (US); James N. Niblick, Knoxville, TN (US)

Correspondence Address: LUCE, FORWARD, HAMILTON & SCRIPPS LLP, 11988 EL CAMINO REAL, SUITE 200, SAN DIEGO, CA, 92130, US

(73) Assignee: InnerTalent Corporation, Encinitas, CA (US)

(21) Appl. No.: 11/357,238

(22) Filed: Feb. 17, 2006

(51) Int. Cl. G09B 19/00

(52) U.S. Cl. 434/236

(57) ABSTRACT

A self-improvement system utilizes psychometric testing and personal development methodologies in a computer-based system that is configured to provide a self-administered, automated self-improvement process. The system is configured to encourage a user to set goals and provides the user with tools to develop skills that are necessary for the realization of those goals. The system also substantively monitors the progress of a users development of those skills by utilizing user inputs received during the process and determining whether the user's views have changed as a result of the development process.

### FIELD OF THE INVENTION

The present invention relates to systems and methods for providing personal development and self-improvement programs to individuals and in particular systems and methods that can be used by individuals to self-administer self-improvement programs.

### BACKGROUND OF THE INVENTION

Interest in tools and programs to facilitate individual self-improvement are increasing rapidly. By one account the demand for products and services in the General Motivational and Self Help segment of the self-improvement market grew at a rate of 37% per year between the years 2000 and 2003, to account for 55% of the overall self-improvement market.

The products and services that individuals use to implement a self-improvement program generally include books, recordings, seminars, and personal coaching. Books and recordings are the least expensive tools for people to acquire, but they are also the least personalized. Typically books and recordings provide only a single success formula for a mass-market and provide only limited user interactivity. Seminars are more expensive than books or recordings and generally do not provide personalization based on individual needs. However, they can provide some degree of interactivity with the presenter of the seminar, depending on the size of the audience. The most personalized and most expensive tool for self-improvement involves the engagement of a personal coach who can tailor a self-improvement program to individual needs and desires. This is akin to engaging a personal trainer for a weight management or exercise program to provide individualized lessons and coaching based on the client needs and skill level.

There is general agreement in the self-improvement industry that engaging a personal coach is the most effective and time efficient method of executing a self-improvement program. It is also the most costly of all the self-improvement methods. In 2003 there were approximately 25,000 personal coaching professionals in the U.S. generating about $1.5 billion in revenues.

Despite the market demand and rapid growth of these services, only a small percentage of people, probably less than 1% of the U.S. population, has ever engaged a personal coach. The primary reason that few individuals avail themselves of these proven and helpful services is primarily due to their high cost. The cost generally limits adoption to high-income individuals or top executives of large organizations who receive such services as a company-paid benefit of employment.

An additional limitation of personal coaching is that its effectiveness is highly dependent on the skills of the individual coach. As a result, the quality of delivered service and consistency of results from one coach to another varies widely.

The development of computer technology over the last decade has increased processing power available on a personal computer has enabled more sophisticated application software and user interfaces and made personal computers easier for non-experts to use. In addition, a rapid increase in the performance and availability of high-speed communications—particularly broadband Internet—have enabled the automation and self-service delivery of applications previously requiring human involvement in the transaction or provision of the service. Examples of common applications that have followed this automation and self-service trend include travel reservations, mortgage and loan acquisition, auctions, car purchasing and retail shopping.

Each of the foregoing fields have developed new ways to provide popular service over the Web, simultaneously eliminating the limits of geography and the need for human interaction in the process. This has reduced the cost of the transaction and delivery while guaranteeing a consistent service quality. All of these services depend in some form on access to multiple, geographically-disparate information sources, and could not exist in their current form without the development of the Internet to its present level of technical infrastructure and adoption by the masses.

Further, many applications have “virtualized” the transaction and interaction between an end-user recipient of a service and its delivery source, thereby removing most traditional constraints of locality in determining the feasibility of the service delivery. As a result, services provided in this way have been able to reach a wider market, create global supply, demand, and competition, provide users with more choices and reduce the cost of these services.

The general belief in the self-improvement industry is that it is not possible to create a fully automated system that is capable of providing an effective and time efficient self-improvement program.

There are numerous systems available that have attempted to provide at least partially automated self-improvement programs. One such system is described in U.S. Patent Application Publication No. 2005/0250081 to Salladay. Salladay describes a system that provides a general assessment of the user in three general areas and assigns primary colors to the results in those three areas. Based on the strengths and weaknesses in each of those areas, the user may be provided color blends that offer a general view of where the users strengths and weaknesses lie. Salladay also indicates that access to the system may be provided over the Internet to one or more users. Although the system provides automated generation of report of a user's strengths and weaknesses, it does not identify user development needs or provide any further steps required in an effective self-improvement coaching process.

U.S. Pat. No. 5,551,880 to Bonnstetter, et al. describes a computerized assessment to predict an individual's suitability for a particular job. The system is used as a screening tool for job applicants rather than a tool to provide self-improvement coaching. As a result it does not address the requirements of a coaching process.

U.S. Pat. No. 6,439,893 to Byrd et al., describes an attempt to address the limitations of the above references. Byrd describes a system in which the Internet allows a client to electronically access assessment tools, similar to those described by Salladay and Bonnstetter. In addition, the system provides an electronic “chat room” where the client may enter a discussion with a personal coach. Although the geographical limitations of interacting with a personal coach may be improved, the system still requires a human coach. Furthermore, since the chat room format still requires a personal coach to be present in the chat room, it does not provide significant cost savings from the more traditional model delivering coaching in person. Another disadvantage of the system is that the client is still subject to the inconsistencies that exist among personal coaches.

U.S. Pat. No. 6,338,628 to Smith discusses an Internet-based system that assesses a user's strengths and weaknesses and automatically provides training and development reminders that are designed to address those strengths and weaknesses. In particular, the program analyzes the user's scores, derived from a test that measures an individual's value profile, and compares the scores against an idealized set of generalized scores. However, those generalized scores are not benchmarked within the context of any specific area of interest (i.e., an area that a person would be interested in benchmarking or improving, such as interests in personal life, career, jobs, or professional roles such as sales or management). As a result, the user is provided with reminders that do not specifically address any area of interest that the user desires to improve.

Another system that provides an assessment and targeted developmental exercises is available through the Internet from Learn To Learn, Inc. of Orlando, Fla. The system is a Web-based application that works at the level of an individual's skills that affect his or her ability to learn, also referred to as “multiple intelligences” by the company. The company founder, Dr. James Fadigan, believes that by diagnosing weaknesses in one or more of these intelligences, and targeting developmental exercises to them, the individual can strengthen them and thereby improve his or her ability to learn. The Learn To Learn system measures learning skills or intelligence, not psychometric, skills. Psychometric testing (also referred to as axiological testing herein) measures such qualities as an individual's personality, behavior, values, and axiological orientation. Science has not shown that a person's intelligence, as measured by standard intelligence tests, is statistically correlated to personality or behavioral traits, or axiological or values orientation. Furthermore, the Learn to Learn system does not include any form of coaching.

In view of the foregoing, it would be desirable to provide a system and method that offers a user automated self-improvement coaching that has improved consistency and lower cost over human coaches.

It further would be desirable to provide a system and method for automated self-improvement coaching that avoids geographical accessibility limitations.

It still further would be desirable to provide a system and method for providing automated self-improvement coaching that is individualized to the user.

It also would be desirable to provide a system that provides personalized coaching at a reduced cost, with improved accessibility and the ability to enlarge the scale of the coaching without significantly increasing the cost.

It would also be desirable to provide a system that allows each user to receive content custom-tailored to his or her specific needs, rather than a stock list of content.

It would also be desirable to provide a system that uses multiple parts of a coaching process and integrates them into a single automated process.

It would also be desirable to provide a system and method for providing automated self-improvement coaching that monitors the user's progress regarding the development of strengths and weaknesses related to a specific area of interest.

### SUMMARY OF THE INVENTION

In view of the foregoing, it is an object of the present invention to provide a system and method for providing automated self-improvement coaching that analyzes a user's proficiency in a plurality of skills related to particular areas of interest and compares them to the scores of an archetypical high performer. The system provides the user with an interactive automated coaching process aimed at improving deficient skills.

Another object of the present invention is to provide a system and method for providing automated self-improvement coaching that records user input regarding personal experiences and self-evaluation and utilizes the user's input during and/or at the end of the coaching process to determine the effectiveness of the coaching process.

A further object of the present invention is to provide a system and method for providing automated self-improvement coaching that provides a user with activities for improving particular deficient skills.

Another object of the present invention is to provide a system and method for providing automated self-improvement coaching while providing a consistent service quality.

Another object of the invention is to provide a system and method where the user can invite and incorporate other individuals of his or her choosing to support and assist his or her self-improvement process.

A further object of the present invention is to provide a system and method that incorporate “best practice” coaching techniques in an interactive automated system.

Another object of the present invention is to provide an automated system of self-improvement coaching that is self-administered by the user.

Another object of the present invention is to provide a method and system to allow the user to set priorities for his or her self-improvement process without the aid of a personal coach or counsellor.

Another object of the present invention is to provide the user a method and system whereby the user can interact with the system to gain expert advice and work through issues that arise in the process as he or she would with a personal coach.

Another object of the present invention is to provide the user a high degree of personalization of his or her self-improvement process, equal to or exceeding the average personalization a personal coach can provide.

Another object of the invention is to provide a method that gives the user control over the determination of whether his or her self-improvement process is complete, for a part, or the entirety, of the coaching process.

An embodiment of the self-improvement system according to the present invention utilizes well-established psychometric testing technology and personal development methodologies in a web-based system that is configured to provide a self-administered automated self-improvement process. The system is configured to encourage a user to set goals and provides the user with tools to develop skills that are necessary for the realization of those goals. The system also substantively monitors the progress of a user's development of those skills.

The invention may be used to provide an automated personal coaching experience for a broad range of areas of interest of user self-improvement including career, life enjoyment and satisfaction, improved relationships and communications with others, and various other life roles the individual is called upon to perform, such as being a parent, friend, or advisor.

In one embodiment, the user is profiled using an established psychometric test that provides a profile of the user as to personality or behavioral traits, or axiological or values orientation. There are a number of generally-accepted and validated instruments for testing individual characteristics traits, tendencies, preferences, and motivators. Preferably, the testing technology yields a broad range of psychometric scores that can be measured against those known or hypothesized to be required for adequate performance in the areas of interest. A subset of the scores measured by the instrument may be used to guide the user in developing the area of interest.

After the user completes the test and selects an area of interest for improvement, he or she may view a report which compares the individual's psychometric scores to those of an archetypical high performer in the area of interest.

All the responses and entries that the user makes are stored in electronic form as part of the user's personal repository. This information may be used in various ways at different steps in the self-improvement process to provide a highly individualized and personally relevant experience.

The collection of the test score, self-score, and the invited participants' average score for the skill in question may be presented to and compared for the user. Differences among these three scores represent an ideal opportunity for the individual to increase self-awareness as he or she considers the implications and causes of the presented differences.

In an embodiment, the system provides multiple methods for the user to reconcile these differences and gain some understanding of why his or her self-view differs from those of others or the objective score of the test. These methods include a novel way to get invited participants to help the user to understand the differences by establishing, with the user's permission, a process for invited participants to provide very specific information about observed user behaviors.

The coaching process provided through the self-improvement system of the present invention is automated to use a methodology based on psychometric science, rather than intelligence and learning.

These and other objects, features and advantages of the present invention will become more apparent with reference to the accompanying specification and claims.

### BRIEF DESCRIPTION OF THE DRAWINGS

Further features of the invention, its nature and various advantages will be more apparent from the accompanying drawings and the following detailed description of the preferred embodiments, in which:

FIG. 1 is a flow chart illustrating the phases of self-improvement coaching;

FIG. 2 is a schematic of an exemplary self-improvement system according to the present invention;

FIG. 3 is a schematic of an exemplary self-improvement program according to the present invention;

FIG. 4 is a flowchart illustrating the process of providing self-improvement coaching according to the present invention;

FIG. 5 is a flowchart illustrating a process for developing an area of interest that may be included in the process illustrated in FIG. 4;

FIG. 6 is a flowchart illustrating a process for assessing skills that support an area of interest that may be included in the process shown in FIG. 5;

FIG. 7 is a flowchart illustrating a process for developing skills that support an area of interest that may be included in the process shown in FIG. 5;

FIG. 8 is a flowchart illustrating a process for providing a substantive skill progress review that may be included in the process shown in FIG. 5;

FIG. 9 is an illustration of a login screen display that may be included in a self-improvement system according to the present invention;

FIG. 10 is an illustration of a general score report screen display that may be included in a self-improvement system according to the present invention;

FIG. 11 is an illustration of a team creation screen display that may be included in a self-improvement system according to the present invention;

FIG. 12 is an illustration of a goal setting screen display that may be included in a self-improvement system according to the present invention;

FIG. 13 is an illustration of a skill quiz screen display that may be included in a self-improvement system according to the present invention;

FIG. 14 is an illustration of a skill relevance screen display that may be included in a self-improvement system according to the present invention;

FIG. 15 is an illustration of a skill self-evaluation screen display that may be included in a self-improvement system according to the present invention;

FIG. 16 is an illustration of a score comparison screen display that may be included in a self-improvement system according to the present invention;

FIG. 17 is an illustration of a first skill activity screen display that may be included in a self-improvement system according to the present invention;

FIG. 18 is an illustration of a second skill activity screen display that may be included in a self-improvement system according to the present invention;

FIG. 19 is an illustration of a third skill activity screen display that may be included in a self-improvement system according to the present invention;

FIG. 20 is an illustration of a skill progress review screen display that may be included in a self-improvement system according to the present invention;

FIG. 21 is an illustration of a second skill progress review screen display that may be included in a self-improvement system according to the present invention;

FIG. 22 is an illustration of a skill progress review screen display that may be included in a self-improvement system according to the present invention;

FIG. 23 is an illustration of an area of interest progress review screen display that may be included in a self-improvement system according to the present invention;

FIG. 24 is an illustration of an area of interest progress review screen display that may be included in a self-improvement system according to the present invention; and

FIG. 25 is an illustration of an area of interest progress review screen display that may be included in a self-improvement system according to the present invention.

### DETAILED DESCRIPTION OF THE INVENTION

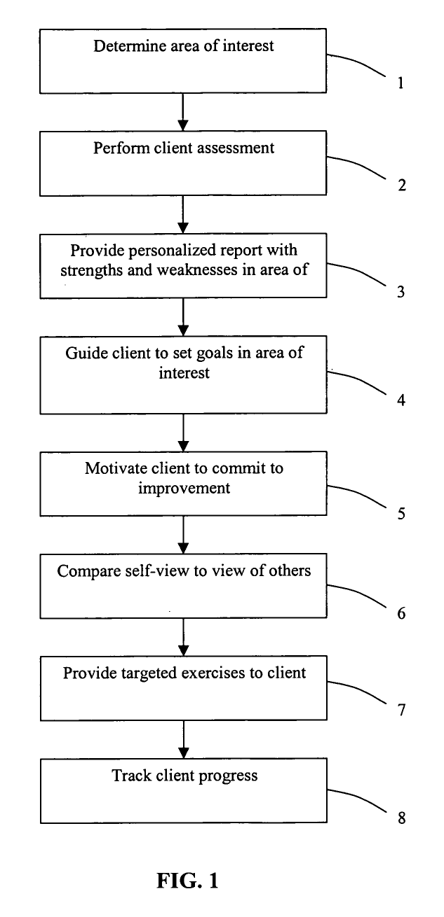

In accordance with the principles of the present invention, an automated self-improvement system is provided. The system enables the integration and sharing of information that is gathered throughout the process. By doing so it provides an effective and efficient coaching that requires a person explore their own experiences with a particular skill as it relates to a particular area of interest. Preferably, the coaching process provided by the self-improvement system includes the following steps, as shown in FIG. 1:

Step 1: Determining the areas of interest in which the user would like to see self-improvement;

Step 2: Performing an assessment of the user to identify their strengths and weaknesses in the areas of interest;

Step 3: Provide personalized report with strengths and weaknesses in area of interest

Step 4: Guiding the user to set clear and well-considered goals related to the areas of interest;

Step 5: Providing motivation to the client to commit to improvement and to make personal change and holding the user accountable for making consistent progress in the areas of interest;

Step 6: Providing a comparison between the user's self-view of his or her strengths and weaknesses and the external view of others;

Step 7: Providing the user customized exercises to develop key weaknesses and to reinforce strengths;

Step 8: Tracking the user's progress through a plan and substantively determining when sufficient personal improvement has been made in an area of interest.

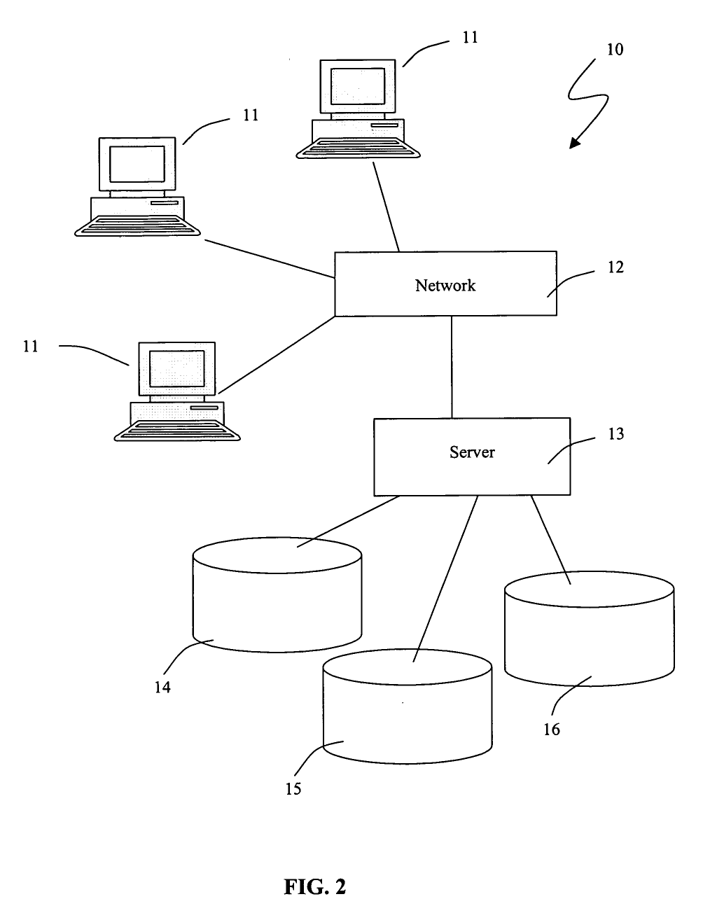

Referring to FIG. 2, self-improvement system 10 generally includes one or more interface units 11 that are configured to communicate over network 12 with server 13. Interface units 11 are used to provide users and optional team members an input/output mechanism for interfacing with self-improvement system 10. Interface units 11 may be personal computers, workstations or any other input/output device that generally allows a user to send or receive text. Furthermore, as used herein the term personal computer includes any device that includes self-contained processing abilities including desktop computers, laptop computers, personal digital assistants (PDA), and handheld computers.

Network 12 is provided to allow communication between interface units 11 and server 13. Network 12 may be any network that is capable of providing communication between the desired interface units 11 and server 13. For example, network 12 may be a local network, such as a company network or a local computer or it may be a larger network, such as the Internet. Server 13 may be any device that is capable of running a computer program that incorporates coaching functions described above and is capable of interfacing with one or more skills databases 14, one or more user repository databases 15 and one or more content databases 16. It shall be appreciated that the databases may be stored on any storage media. Furthermore, it shall be appreciated that any combination of the skill, user repository and content databases may be combined in a single database.

In a preferred embodiment, interface unit is configured to allow the user to log on to an Internet location and create a unique user account which will link the user to a personal identification number (PIN) or other secure identification such as username and password so the user can uniquely be identified with his or her test results and personal coaching program. A unique electronic user profile is created within user repository database 15, where the PIN and log on and other information unique to this user will be stored.

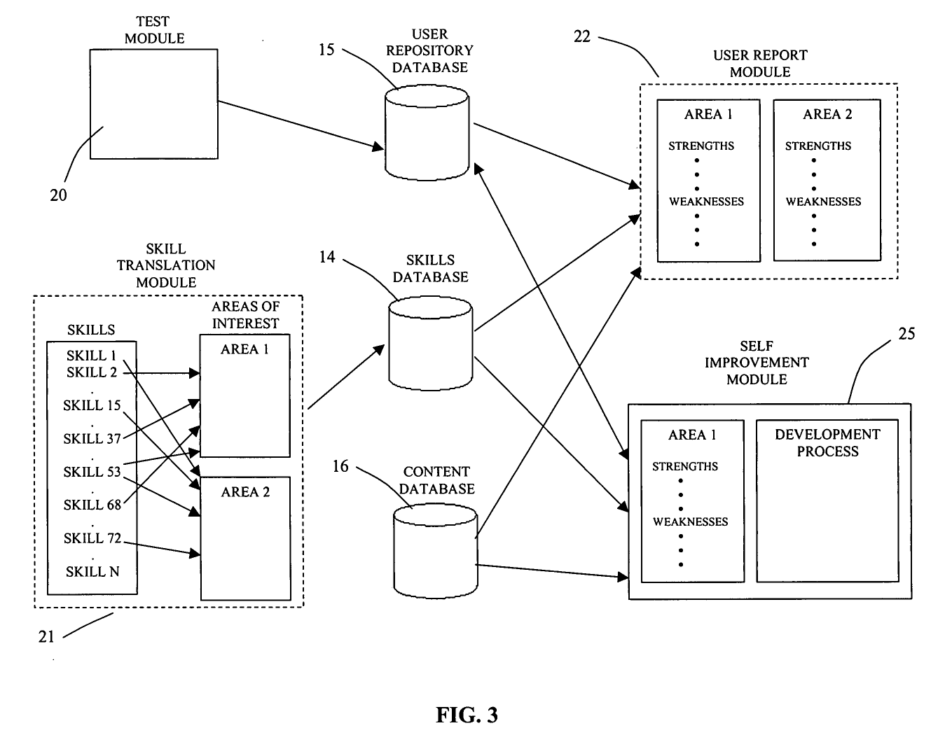

The self-improvement system generally includes a group of logic modules that manipulate and analyze input from the user and to provide output regarding the coaching steps described above. Referring to FIG. 3, self-improvement system 10 generally includes test module 20, skill translation module 21, user report module 22, skills database 14, user repository database 15, content database 16 and self improvement module 25.

Test module 20 provides the user with a test that requires the user to perform a function, such as selecting among a set of preferred answers to a plurality of questions, or ranking a plurality of statements, that may be analyzed to provide insight into the psychometric traits of the user. The test may be any test that is known in the art and is recognized to provide reliable data regarding psychometric traits. For example, in an embodiment, test module 20 presents the user with an axiological profile test. The responses to the test may be communicated to user repository database 15 for later use by user report module 22 and self improvement module 25.

Skill translation module 21 is used to resolve individual skill scores gathered by the test utilized in test module 20 into skill groups, or competencies. Competencies are the building blocks that are necessary for success in a particular area of interest. As mentioned above, an area of interest is any area that a person would be interested in benchmarking and/or improving. Areas of interest can include a broad range of possible improvement areas such as job and career (for example becoming a better manager or salesperson), relationships (including business, personal, family, or romantic), interpersonal communication (friends, family or colleagues), life skills (such as successfully balancing work and life demands) and personal skills (such as leadership and self-confidence). For example, particular areas of interest presented by the system may include leadership, balancing work and life, management, realizing (or finding) a dream job and selling ability. Skill translation module 21 generally interfaces with skills database 14 which may be used to store information regarding the relationship between individual skills, competencies and areas of interest, which is delivered to the user.

Content database 16 also may be included in the system. Generally, content database 16 contains the background, explanatory and exercise-related information that is presented to a user throughout the self-improvement process provided by the system. Content database 16 may contain skill specific information, such as an introductory or importance information regarding a skill. Content database also may contain questions and/or activities that are provided during the skill development process described below. As shown in FIG. 3, content database 16 is configured to communicate with user report module 22 and self improvement module 25 so that information contained in content database 16 may be presented during any part of the self-improvement process.

The system also may include user report module 22, which may be configured to provide various reports to the user regarding individual skill scores or combined scores related to any particular area of interest or combinations thereof. In an embodiment, user report module 22 provides a first report that indicates general scores for each of a plurality of areas of interest based on a subset of skills required for the area of interest that may be referred to as core skills.

User report module 22 also may provide a more detailed report that lists the subset of skills categorized into a particular area of interest and indicates those skills with the highest and lowest scores. In an embodiment, user report module 22 indicates the five (5) lowest scoring skills for a particular area of interest. In an embodiment, the system is configured to generate up to eighty (80) unique skills based on the user's input from the test module. It shall be appreciated that each area of interest may be supported by any number of those skills and any particular skill may be required for success in multiple areas of interest.

The system also includes self-improvement module 25, which allows a user to develop particular skills. Self improvement module 25 is used to interface with a user regarding particular areas of interest and skills associated therewith. Self improvement module 25 interfaces with a user regarding goals and provides reminders and development exercises related to skills associated with an area of interest as will be described below. Self improvement module 25 also may interface with user repository database 15 which may be utilized to store data regarding a particular user. For example, user repository database 15 may be used to store data regarding skill scores, responses to inquiries, and/or a record of progress through the development process. It shall be appreciated that self improvement module 25 may also provide the user with skill reports and interfaces so that the user may select a weak skill and develop it. In an embodiment, self improvement module interfaces with user repository database 15 and skills database 14 to re-create the list of skill strengths and weaknesses for a particular area of interest similar to that provided by user report module 22. It shall be appreciated that in an alternative embodiment, that list may also be created by just one of user report module 22 or self improvement module 25 and that information may be stored or created as required in conjunction with user repository database 15.

In a preferred embodiment, self improvement module 25 provides a method for the user to invite others to participate in his or her self-improvement coaching process. Self improvement module 25 may lead the user through an interactive process of setting personal goals in the area of interest, following a process and providing guidance and questions typical of a goal-setting session with a personal coach. Self improvement module 25 also may ask the user questions about specific performance issues in the areas of interest, based on predictions of likely scenarios derived from the test results. In the embodiment, the user interacts with the system to document personal examples of behaviors and outcomes in the prompted scenarios. The goal of this part of the process is to create a personal or emotional connection between the skill under development and the user's past experiences, particularly unpleasant ones where the user did not exhibit mastery of the skill under development. This connection is an important basis for creating motivation to change, a key role a personal coach would play.

Furthermore, preferred self improvement module 25 also includes learning exercises where the user is provided basic information about the skill under development, which can include information such as the definition of the skill, how the skill is used, and why it is important. The user also may be provided with an automated quiz about the material he or she has learned about the skill, in order to measure skill understanding before moving further in the process and the user is provided a score and is given the option to take the test over again if the user is not satisfied with his or her score.

Preferably, the user is given the opportunity to rate himself or herself on the skill under development. The self-improvement module also presents a survey to the individuals that the user invited to participate in his or her self-improvement coaching process. Based on these survey results, the system derives a representative score for the skill under development as rated by others who have observed the user's behavior in situations that called for this skill and presents a comparison of his or her self-score, the invited participants' score and the test score. Self improvement module 25 also may provide a mechanism for resolving the cause of any differences among these scores and a series of suggestions, ideas to consider and specific exercises to strengthen the skill under development.

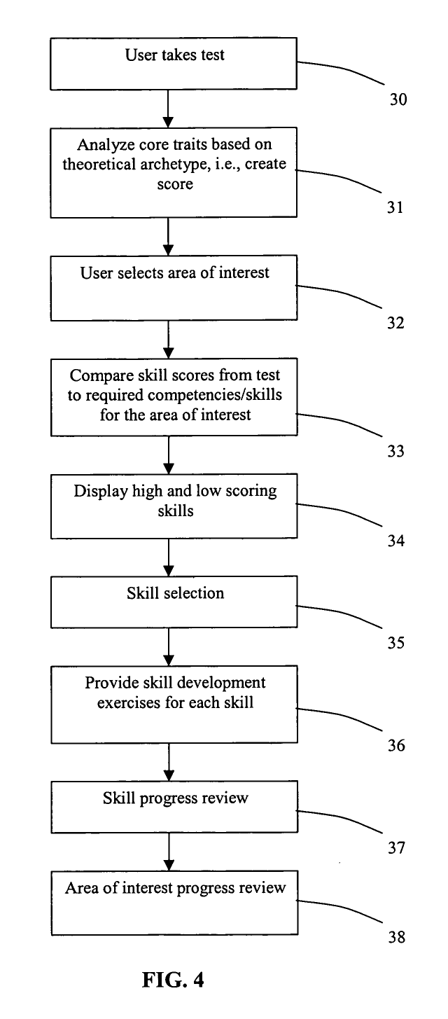

Referring to FIG. 4, a method of using the self-improvement system according to the present invention generally begins with the user taking a test, indicated by box 30, that is designed to analyze psychometric skills of the user. As mentioned above, one such test is the Hartman Value Profile test.

Next, the system provides a report that compares the individual's psychometric scores to an archetypical high performer in the area of interest, indicated by box 31. It shall be appreciated that those preliminary scores may be based on scores for a group of skills that is a subset of the skills generally required for the particular area of interest. For example a subset psychometric scores which are of primary relevance to the area of interest may be considered. The primary skills required for the area of interest may be identified through some combination of the literature, common industry knowledge, or direct interviews with recognized experts who are knowledgeable about the key psychometric scores required for success in the area of interest, based on primary research or field experience. The archetypical baseline scores may be obtained though some combination of the relevant literature, common industry knowledge, or a statistical study that compares the scores of generally acknowledged high and low performers from a selected population in the area of interest.

A unique feature of the present invention as compared to the art is that it may alert the user when one or more of his or her psychometric scores may be higher, not just lower, than the archetypical score. For example, an overabundance (high score) in empathy for others can limit performance in certain types of sales roles.

Another unique feature of the current invention is that it provides a single score on a standardized scale (such as 1-5, 1-10 or 0-100) for an area of interest. Examples in the art typically provide multiple single psychometric scores, or groups of scores, but not a single score that summarizes a person's overall fit in an area of interest. This single score is provided based on an algorithm that scores and weights the individual's scores against the archetype.

After the scores are displayed, the user is prompted to select an area of interest for further development, as indicated by box 32.

As mentioned above, a unique subset of the skills scored through the psychometric test are associated with success in a particular area of interest. A listing of skills for each area of interest may be stored in a skills database. A list of key performance metrics may be compiled for each area of interest based on attributes shared by model performers in the area of interest. For example, the key performance metrics for selling (an exemplary area of interest) include various competencies which include the ability to identify potential customers, the ability to contact those potential customers, the ability to prioritize potential customers, the ability to develop relationships with the potential customers, the ability to convert potential customers into actual customers by closing deals and the ability to complete the transaction and acquire a reference. Furthermore, each competency requires a plurality of particular skills such as self starting ability, personal drive, creativity, problem solving ability, role confidence and self direction that are scored in the psychometric test.

After the user selects the desired area of interest the development of the area begins. Scores on the skills relevant to the area of interest, based on the list of key performance metrics for the area of interest, are collected from the output of the test module (box 33). After the scores are collected, the user gets a personalized report based on the skills required for the area of interest and his or her high and low scores, indicated by box 34. The self-improvement module will use the test results to recommend key skills for the user to develop to increase performance and satisfaction in the area of interest. The user can select which of these skills to begin working on.

After the high and low skill scores are identified, the user is prompted to select a particular skill for development (box 35). Upon making the selection, the self-improvement system takes the user through a series of steps that allow the user to learn about the skill, determine his proficiency in the skill and engage in various activities designed to develop the skill as indicated by box 36. Upon completion of the skill development process, the user's progress is tested and the system determines whether the user has developed the skill sufficiently in box 37. Finally, after the user has completed the development process for all of their weakest skills, the system presents the user with information that they entered at the beginning of the development process to determine if the skill development has influenced their ability in the area of interest (step 38).

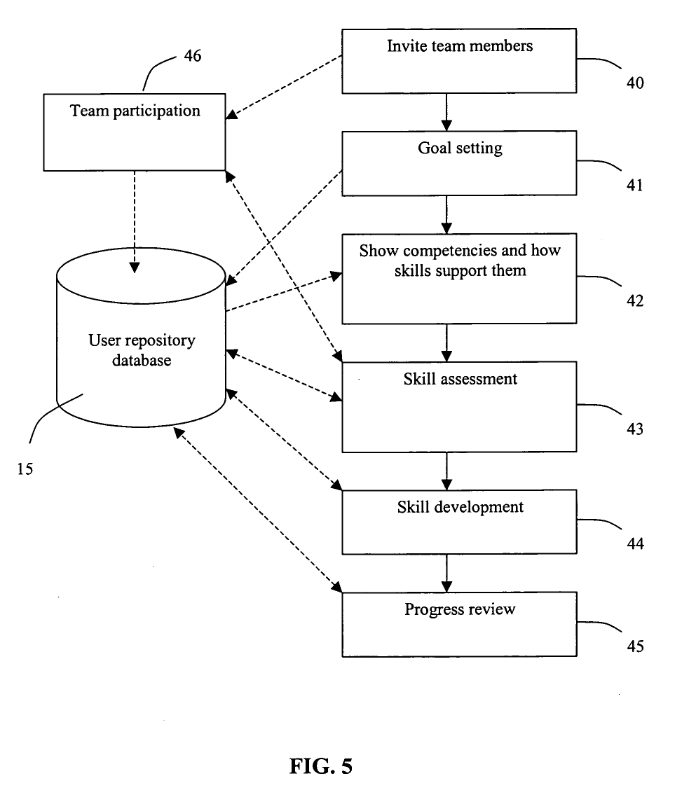

Referring to FIG. 5, in a preferred embodiment of the present invention, the first step in the skill development process is to optionally create a support team (step 40). The support team may be a group of individuals that the user selects and requests to participate. Preferably, the team includes five (5) or more people that are selected based on their ability to help the user develop desired skills. Team members may be anyone the user selects such as friends, family members and/or colleagues.

After the information regarding requested members is entered by the user, the system attempts to communicate with the requested member. For example, the system may send a message, such as via email, that inquires whether the requested team member is willing to participate. If the team member elects to participate, indicated by box 46, they are requested to rate the user regarding the user's ability related to one or more of a plurality of particular skills. The team member may be required to enter a score in any form, such as by selecting a score from one (1) to ten (10). It shall be appreciated that any scale or scoring configuration may be used.

The next optional step in the development process requires the user to set goals directed to the area of interest (box 41). During the step, the user is instructed regarding the role their goals play in their development and why setting personal goals is important. The user is also guided through a goal setting process. In an embodiment, the user may create up to ten (10) goals related to the selected area of interest. It shall be appreciated that the system may allow the user to create any number of goals.

Following the creation of goals, the user is instructed regarding the area of interest and the competencies and skills required to support the area of interest are displayed, as indicated by box 42. A list of the required skills is presented to the user, which indicates which skills received the highest and lowest scores. Preferably, the five (5) highest and the five (5) lowest scored skills are indicated graphically, such as by colored fonts. It shall be appreciated that more or less than five (5) of the highest and lowest scored skills may be indicated. It shall further be appreciated that those indicated scores may be distinguished in any manner, such as font style, color or size, or by any other distinguishing feature.

The list allows the user to select one of the lowest scored skills for assessment (step 43) and development (step 44), each of which may include multiple steps or activities as described below. Finally, after completion of the skill assessment and development, the system performs a progress review specifically focused on that skill, as indicated by box 45.

Information regarding the user and their skills is gathered throughout the process as indicated by the dashed arrows of FIG. 5. In particular, when a prospective team member agrees to participate the scores that they provide are stored in user repository database 15. Similarly, goals set by the user in step 41 are also stored in user repository database 15. In addition, during the subsequent steps in the self-improvement process, information regarding the user may be stored in the database and/or retrieved so that it may be used throughout the process, as described in greater detail below.

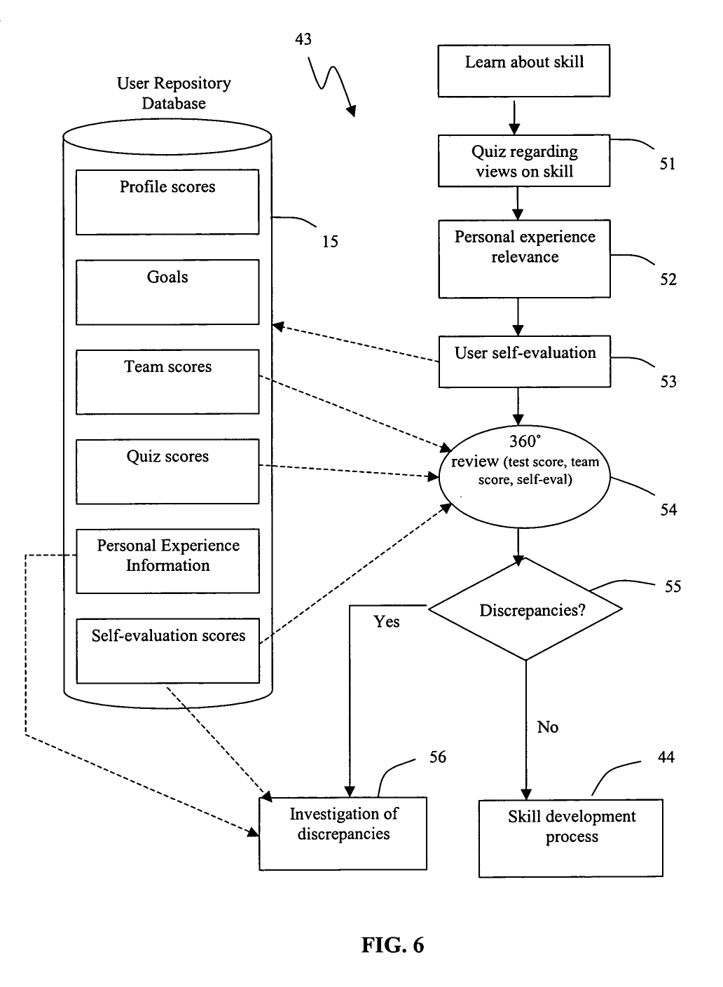

Referring to FIG. 6, skill assessment process 43 generally includes multiple steps that retrieve information from the user and provide comparisons of the gathered information. The information is stored in user repository database 15 so that it may be used throughout the self-improvement process. It shall be appreciated that the passage of information is generally shown with dashed arrows throughout FIGS. 6-8.

Generally, the first step in assessing the particular skill is to provide the user information about the skill and its importance, as indicated by box 50. This information can be provided in a plurality of media, such as written text, audio, video, graphics.

After the user is provided an introduction of the particular skill the system provides a test of the user's knowledge of the skill, as indicated by box 51. It shall be appreciated that any test may be included, for example, the user may be asked to answer questions regarding various scenarios. Furthermore, the questions may be in any format such as multiple choice or true/false. In an embodiment, the user's knowledge may be tested by providing a quiz that a includes multiple sets of statements and the user is asked to select the statement that is most relevant to the particular skill of interest. Upon completion of the quiz, the user's scores are stored in user repository database 15.

As mentioned above, a particular area of interest may be selling. One of the skills necessary for being successful at selling is the ability to stay focused on a goal. Based on that skill a user may be requested to select an attribute of the skill. In particular, the user may be required to select from the following attributes the one that is most closely associated with the ability to stay focused on a goal:

1) the ability to stay motivated;

2) being able to recognize the most important aspects of a project;

3) being able to focus on results; and

4) being able to focus on successes instead of failures.

The next step, indicated by box 52, is the collection of information regarding the user's experiences related to the skill. Such a step is designed to create personal relevance of the skill for the user by reflecting upon experiences in their life where the lack of development of the skill created an issue. This step helps to motivate the user to commit to change. During the step, the user may be asked as series of questions related to the skill. The information entered by user is transferred to the user repository database 15 for later use, similar to the user's quiz scores from step 51.

In one embodiment, the user is asked to answer the following five (5) questions related to their personal experience with a particular skill:

1) describe a situation in which your shortcoming in the ability to stay focused on the most important issues caused a problem;

2) describe an instance where your lack of the ability to prioritize appropriately across multiple assignments created issues for you or others;

3) describe a time when your limitation in the capacity to be creative in working around new challenges created difficulty;

4) describe a situation where your weakness in recognizing the most important elements of a process caused some kind of challenge; and

5) describe a time when your insufficiency in the ability to focus on results became an issue.

Next, the user may be asked to evaluate their own ability with regard to key attributes related to the skill (box 53). For example, the user may be provided with a list of attributes and asked to select a score that reflects there ability for each attribute. The user may be asked to select a score on any scale such as by selecting a number between one (1) and ten (10). Preferably, the scale utilized in this step of the skill assessment sub-process is identical to the scale used by the team members in rating the user. It shall be appreciated that any scale may be used for rating the attribute. Again, the scores that are entered by the user in step 53 are stored in user repository database 15 for later use.

In an embodiment, the user is provided with a list of five (5) attributes and required to select a number that reflects their self-evaluation of their ability. For example, the attributes may include:

1) the ability to stay focused on a goal without getting distracted;

2) the ability to prioritize events appropriately across multiple projects;

3) the capacity to be creative in the face of unforeseen obstacles;

4) recognizing the most important elements of a process; and

5) the ability to focus on results, without wasting time on unimportant issues.

After the user has rated himself or herself, the system provides a report indicated by box 54 comparing the scores collected from the team members, the scores from the test, and the user's self evaluation from step 53 which are stored in user repository database 15. Such a review may be referred to as a 360° view because it provides the user with a clear comparison between their self-views, how others view them and on how the user's test score reflects their ability in the particular skill attribute.

The system then provides the user with options to continue. For example, if there are large discrepancies between the scores, the user is presented with decision 55 whether to investigate the source of the discrepancies, indicated by box 56. If the scores are consistent the user may progress to skill development process 44.

If the user chooses to investigate, step 56, they may be provided various options for investigating differences between the scores so that the user can assess shortcomings. Such options include allowing the user to review the information they entered for their personal relevance experiences earlier. If the user selects this option, the system retrieves information provided by the user during the relevance step (step 52) from user repository database 15 so they can review and contemplate their answers.

Another option provided by the system is for the user to review their self-evaluation. That option allows the user to review the scores they gave themselves during the self-evaluation step (box 53) that were stored in user repository database 15.

A further option includes the system providing a series of coaching questions that are designed to help the user reconcile the differences between the scores. The coaching questions may request the user to describe their thoughts about the differences between the scores. The questions also may ask the user to consider whether their self-evaluation would be different if they could review their actions and behaviors from a neutral perspective. Any number of questions in any format may be presented. For example the questions may require the user to enter descriptions or to simply select from a list of options.

The system also may allow the user to contact team members to inquire about their views on the differences in the scores. Through such an option, the user may select individual team members to contact. In an embodiment, after the user selects which team members to contact the system provides a form letter requesting the team member to respond which incorporates information of relevance from user repository database 15 about the skill under investigation. If the team member elects to respond, the system may provide them with a hyperlink that directs them to an interface screen that prompts the team member to enter their thoughts regarding specific score differences. The system may also provide the team member with guidance regarding effective techniques for providing their feedback. It shall further be appreciated that the feedback provided by the team member may be in any form.

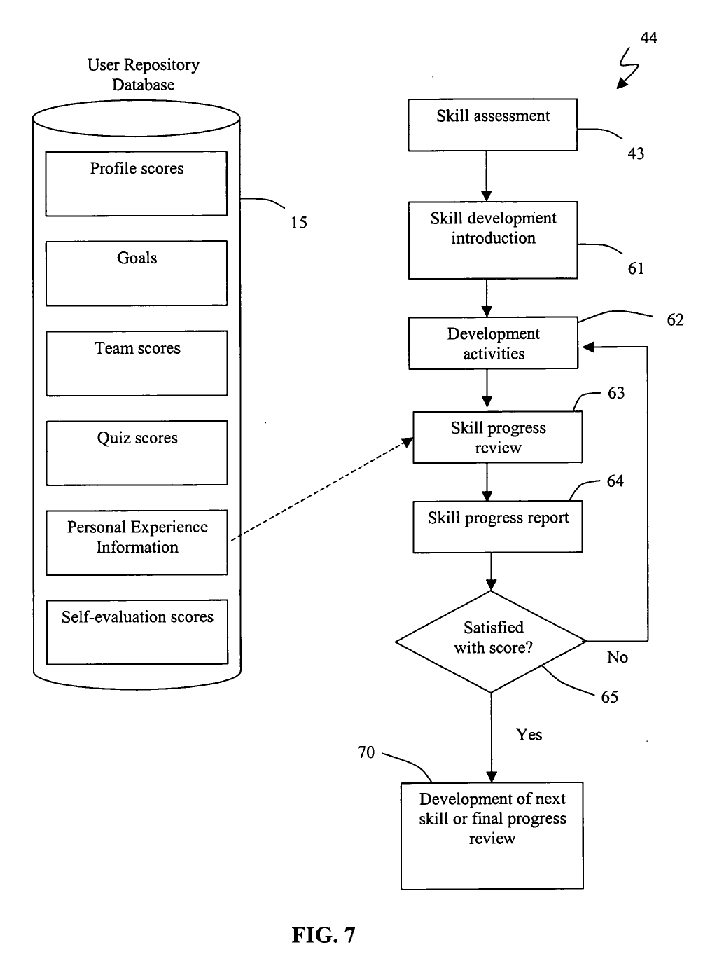

After the user has completed the desired options of skill assessment 43, they may begin development of the skill. Referring to FIG. 7, development process 44 of the skill may start with an introduction to the development process including helpful ideas related to the development of the skill, as indicated by step 61. During that step, the user may elect to have the system send tips related to the skill, or inspirational quotes in the form of daily email reminders. It shall be appreciated that these tips can be in any form and can be delivered to the user in a plurality of ways, preferably electronically.

After the user has reviewed the introduction to the development of the skill and determined whether to receive reminders, the user is offered a series of activities (step 62) that are designed to develop the selected skill. Any activities may be provided that are designed to develop the particular skill, such as any activity recognized in the art to provide such development. Information regarding the completion of the activities and any information entered during participation in the activities may be stored in user repository database 15.

Upon completion of the skill development activity step 62, the system provides the user with a skill progress review 63 that may be used to assess the user's development progress. During the review, the system may retrieve information regarding the skill that was entered by the user during skill assessment 43 and stored in user repository database 15. In particular, in an embodiment, each description regarding experiences related to the skill that was entered by the user and stored in user repository database 15 is presented and the user is asked whether they would handle the situation differently.

A skill progress score is calculated based on the user's answers. The system then may provide a report of the score (step 64) and requests that the user decide whether they would like to continue developing the skill (step 65). In the event the user opts to continue developing the skill, further activities may be provided. If the user decides they are satisfied by the results of skill progress review 63 they may elect to continue to the next skill or, as described below, they may proceed to a final review process 70.

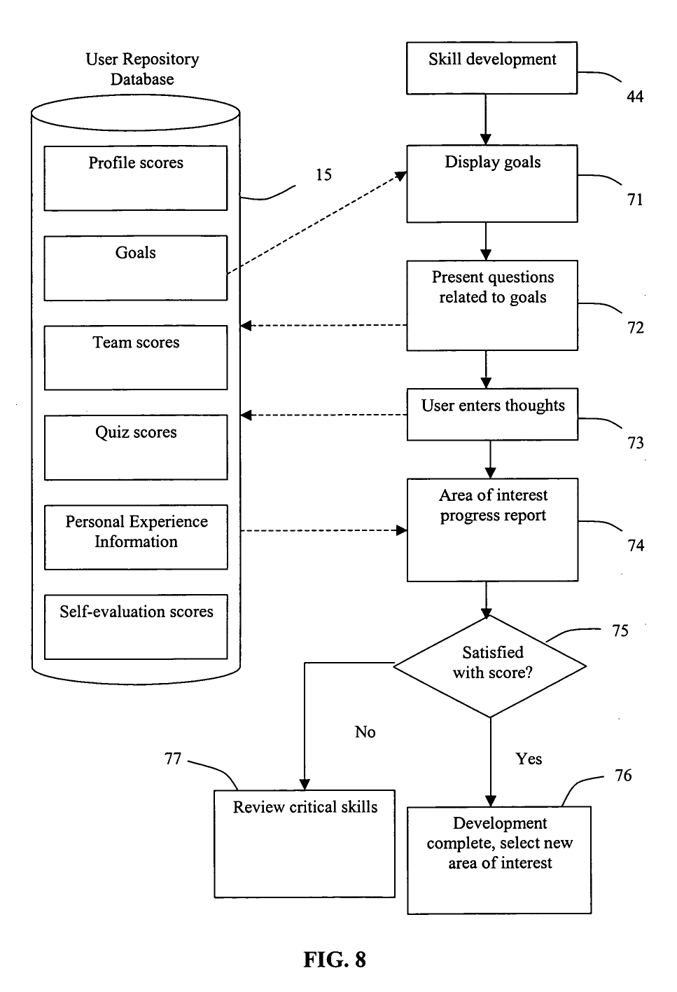

Upon completion of the development for the skills identified as weaknesses, the user may elect to proceed to final review process 70. Referring to FIG. 8, in an embodiment of the present invention, the final review begins by presenting the user with the goals (step 71) that were entered at the beginning of the self-improvement process and stored in user repository database 15. The system then requests the user to provide responses to questions related to the goals, such as their confidence in their ability to meet those goals, as indicated by box 72. The answers are then stored in user repository database 15. After the user answers the goal-related questions they may be asked to respond to questions related to the area of interest (step 73).

For example, the user may be asked to enter their thoughts on what they have learned and how they plan to continue to develop in the area of interest. Their responses may then be stored in user repository database 15. Next, the system provides a score report for the user's progress in the area of interest (step 74). Such a report may be based on any of the information gathered during the process. The score may be based on the responses to the questions related to the goals that were collected during step 72 of final progress review 70. Finally, upon receiving the score report, the system requests the user to decide whether they are satisfied with the scores (step 75) and would like to proceed to development in another area of interest (step 76) or if the user is unsatisfied and would like to review the critical skills and continue the development process (step 77).

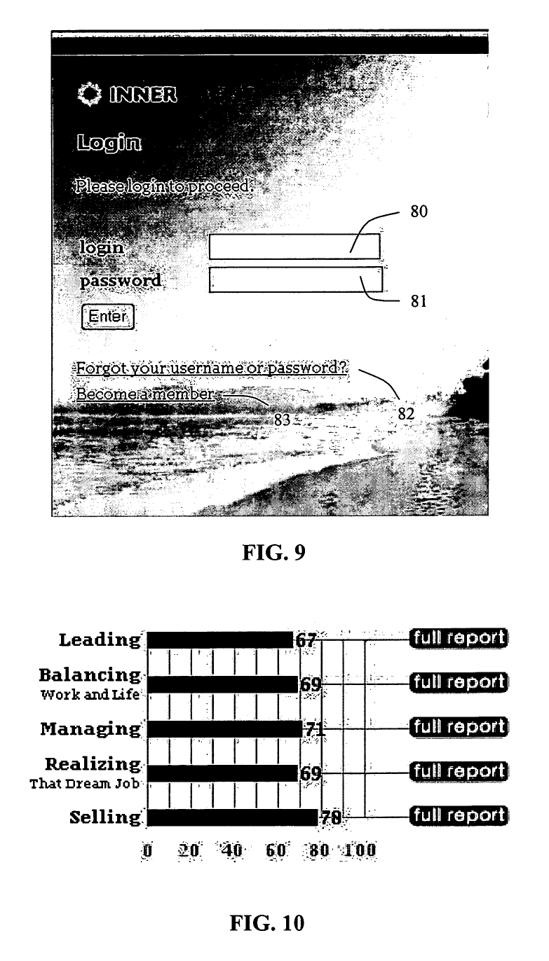

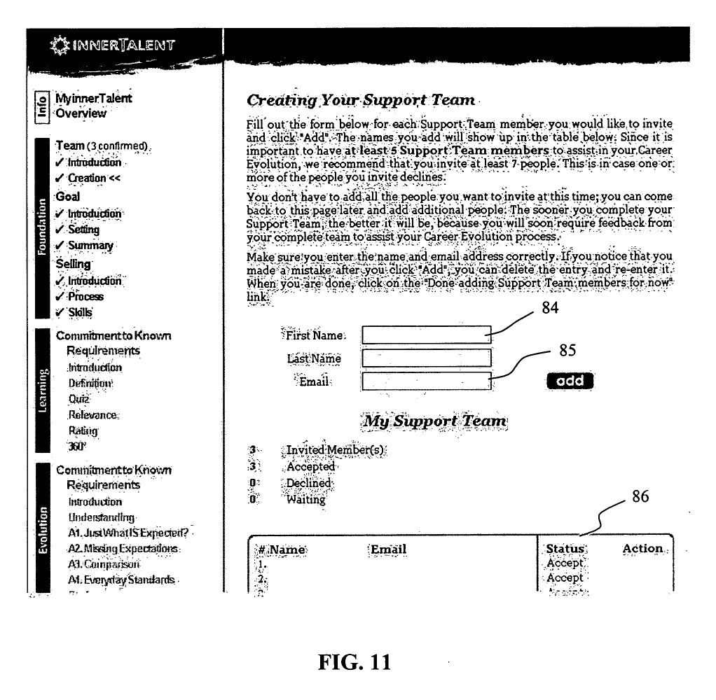

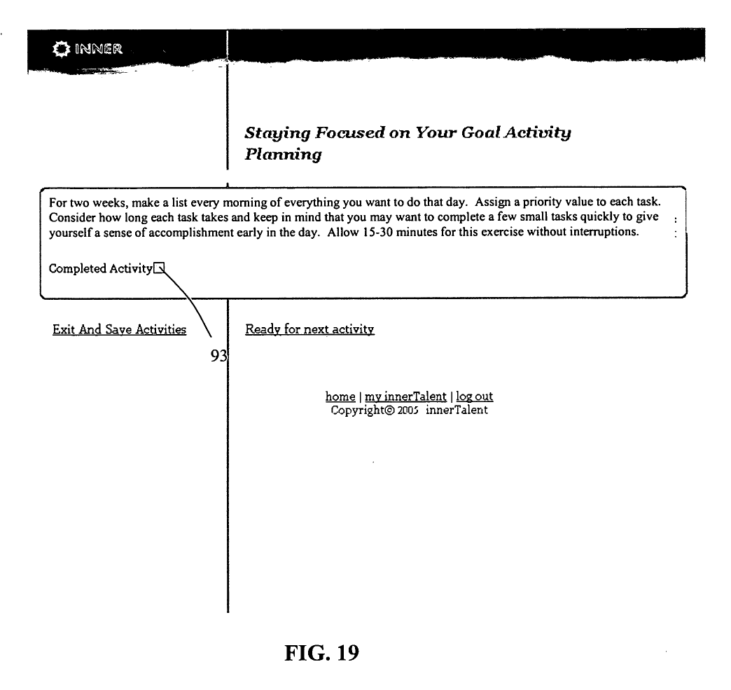

Referring to FIGS. 9-25 exemplary screens provided by an interface unit in an embodiment of the present invention are shown. In particular, FIGS. 9-10 are exemplary screens that are not dependent on the user's selection regarding a particular area of interest. FIGS. 11-25, however, are illustrative of a self-improvement process in which the user has elected to develop a “Selling” area of interest and the skill of “Staying Focused on Your Goal” which is required for success in that area of interest.

A user may log onto the self-improvement system through a login screen such as that shown in FIG. 9. The login screen may include a username entry field 80 and a password entry field 81. As shown, the login screen also may include an option 82 for the user to select if they have forgotten their username or password and an option 83 for the user to select if they have not yet created a user account.

After logging into the system, the user takes the profile test and based on the test scores, the user is provided with scores for particular areas of interest, as shown in FIG. 10. In the embodiment shown, scores are provided for areas of interest that include leadership, balancing work and life, management, realizing (or finding) a dream job and selling ability. As discussed above, the scores shown may be based on a core set of skills supporting each area of interest.

Furthermore, the user is permitted to choose an area of interest and based on their choice a list of skills required for success in the area of interest is presented. The user then is permitted to select a particular skill for development and begins the development process by creating a support team. The user is prompted to create a support team through a screen as shown in FIG. 11. The support team creation screen includes entry fields for the prospective team member's name 84 and email address 85. The team creation screen also includes a chart 86 indicating the status of the team member requests. For example, chart 86 lists the prospective team member's name and email address and status with regard to whether they have decided to participate.

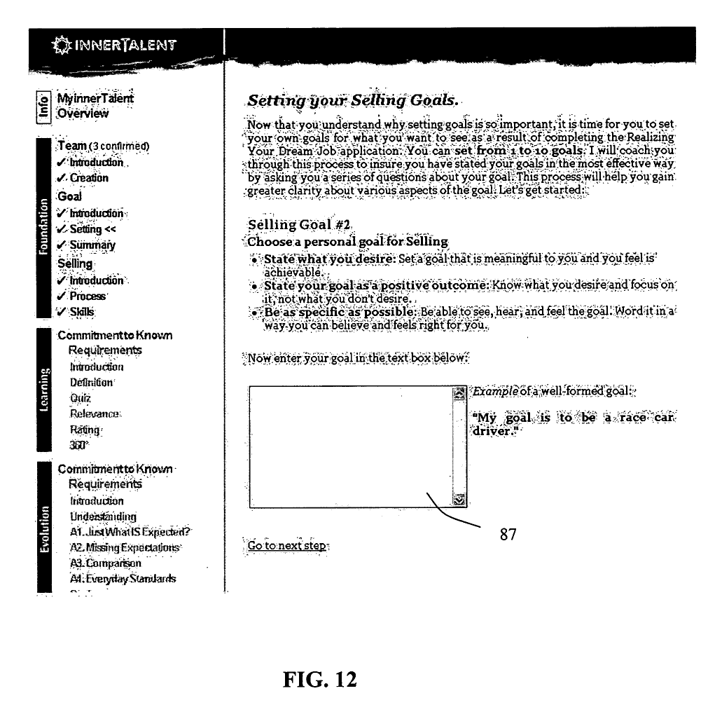

After a support team is created, the user is prompted to enter skill specific goals through a goal setting screen, shown in FIG. 12. The screen may provide guidance for setting goals and examples of goals. The screen may also include a goal entry field 87 that enables the user to enter their goal. It shall be appreciated that one or more goals may be entered by the user through any number of goal setting screens.

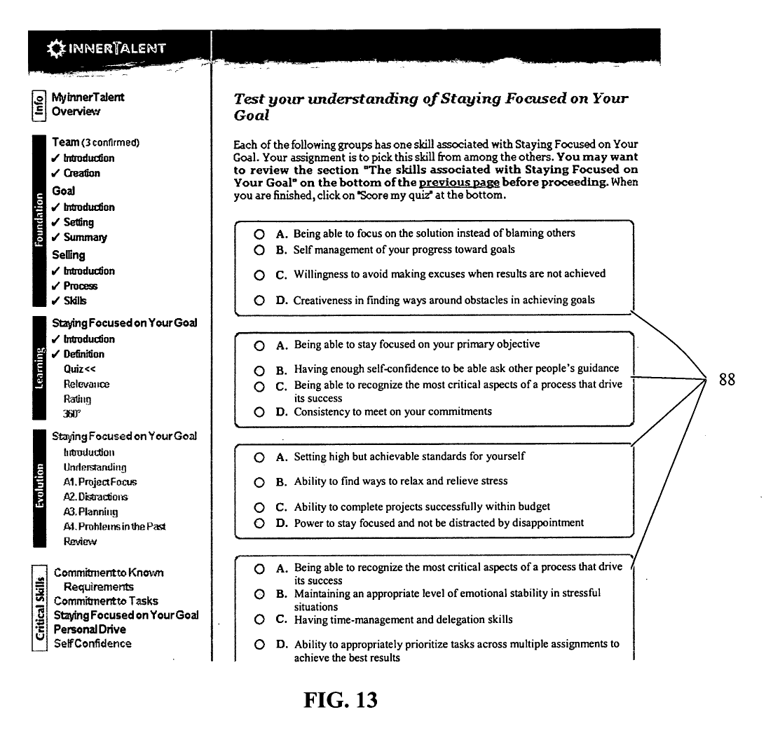

Following the creation of a team and setting goals, the user is provided with a quiz that begins the skill assessment process. As previously mentioned, the quiz may be provided in the form of multiple groups 88 of statements and the user may be required to choose the statement that is most closely related to the particular skill, as shown in FIG. 13.

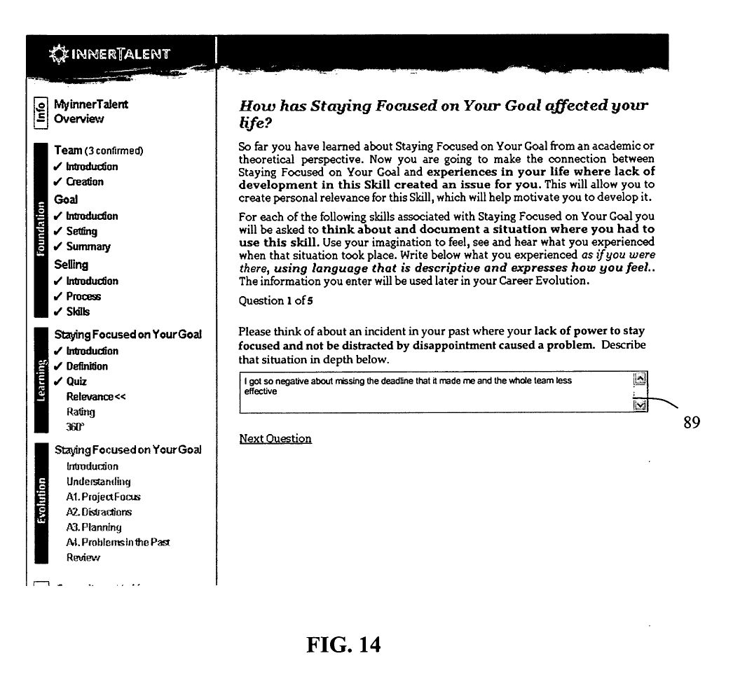

After the user has taken the quiz, shown in FIG. 13, they are prompted to describe experiences related to the skill at issue through a screen such as that shown in FIG. 14. The screen may include a short request that encourages the user to think of an experience that is related to a specific attribute associated with the skill. The user may enter a description through an entry field 89. It shall be appreciated that multiple screens similar to that shown may be provided so that the user may enter descriptions of multiple experiences.

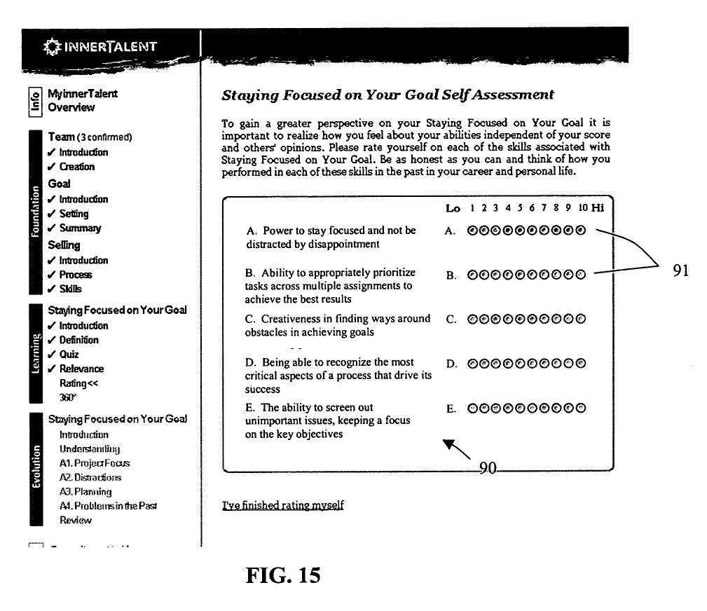

The step of self-evaluation may be performed through the screen shown in FIG. 15. The self-evaluation screen may provide a list of attributes 90 related to the skill and the user may be requested to provide a score for each of the attributes. As shown, multiple score selection boxes 91 may be provided so the user may select a score simply by selecting one of score selection boxes 91.

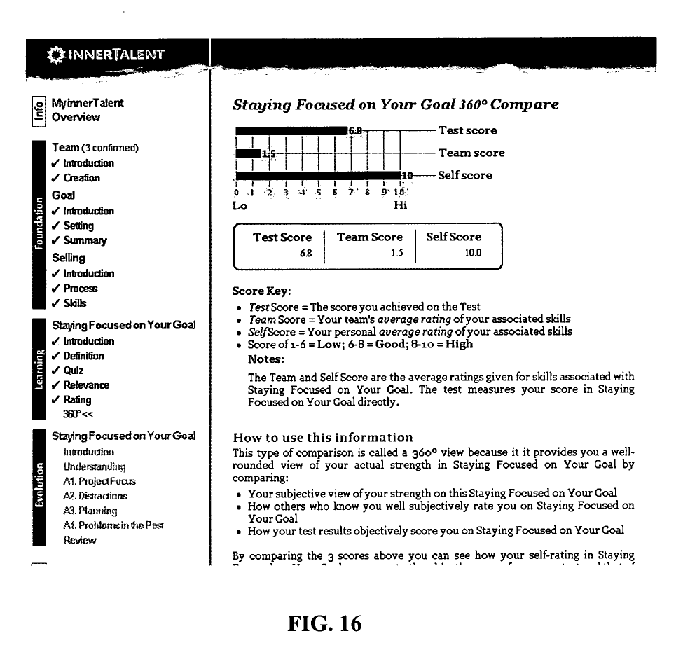

On the next screen, the 360° comparison is displayed as shown in FIG. 16. The user's test score, support team score and self-evaluation scores are all displayed on the screen. Furthermore, it shall be appreciated that although it is not shown, the options provided to the user to investigate score discrepancies may also be provided through this screen.

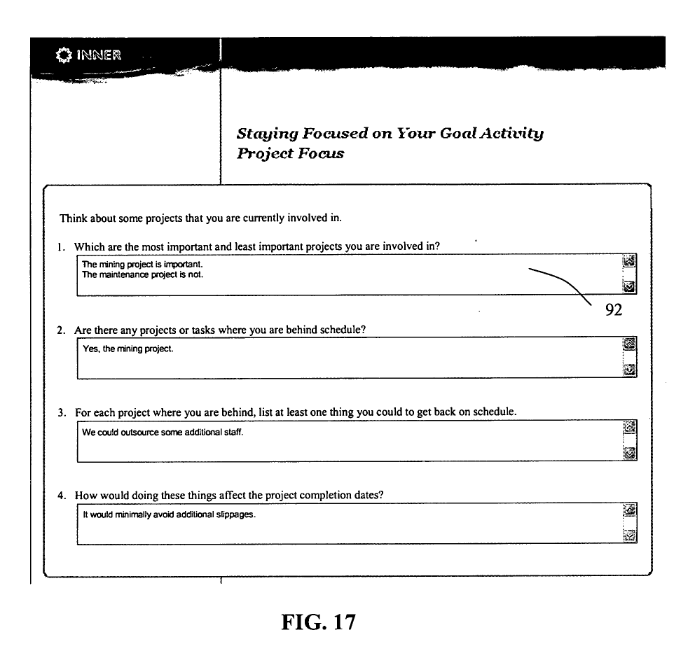

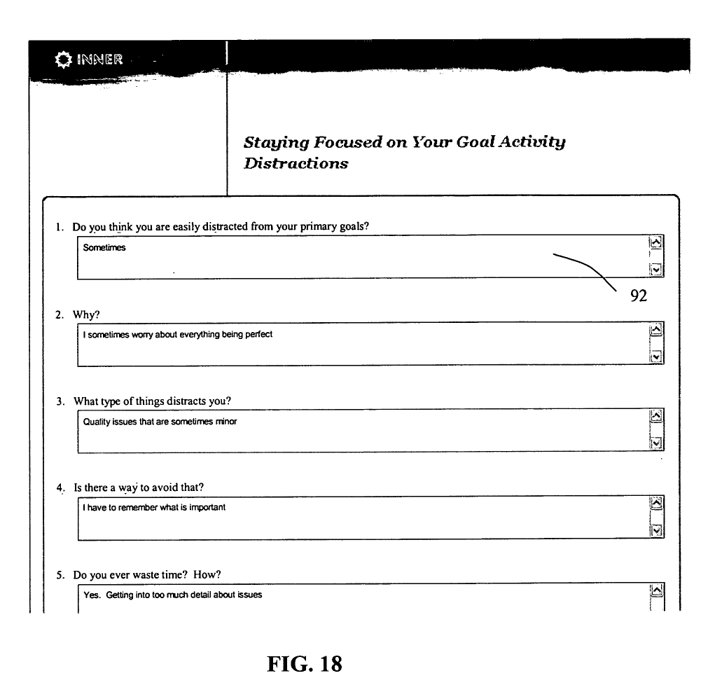

FIGS. 17-19 illustrate three (3) activity screens that may be used to develop the skill of staying focused on a goal. As illustrated by the screens, the activities may have any form, such as entry fields 92 for a user to respond to specific inquiries or it may include a specific activity and a check box 93 to indicate completion of the activity.

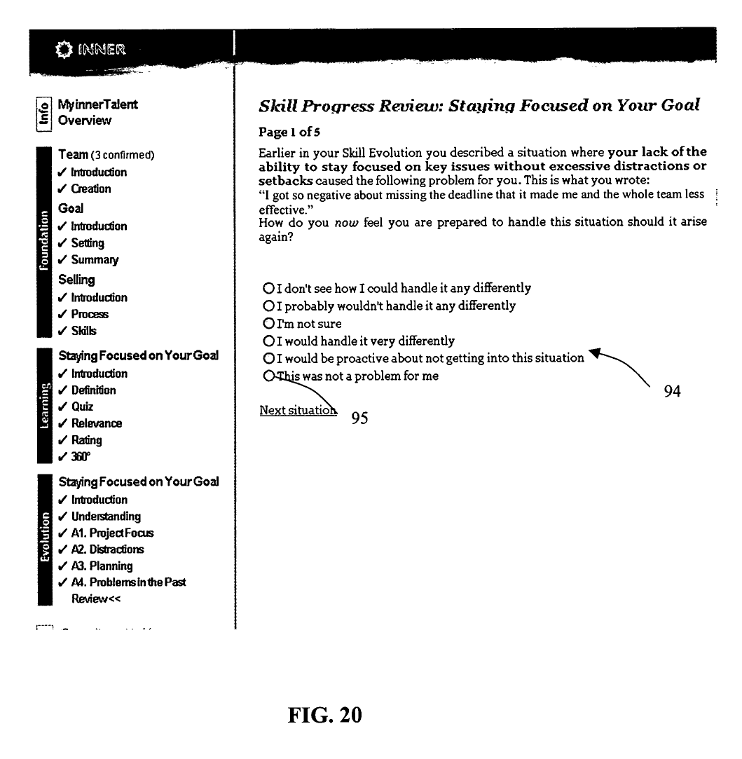

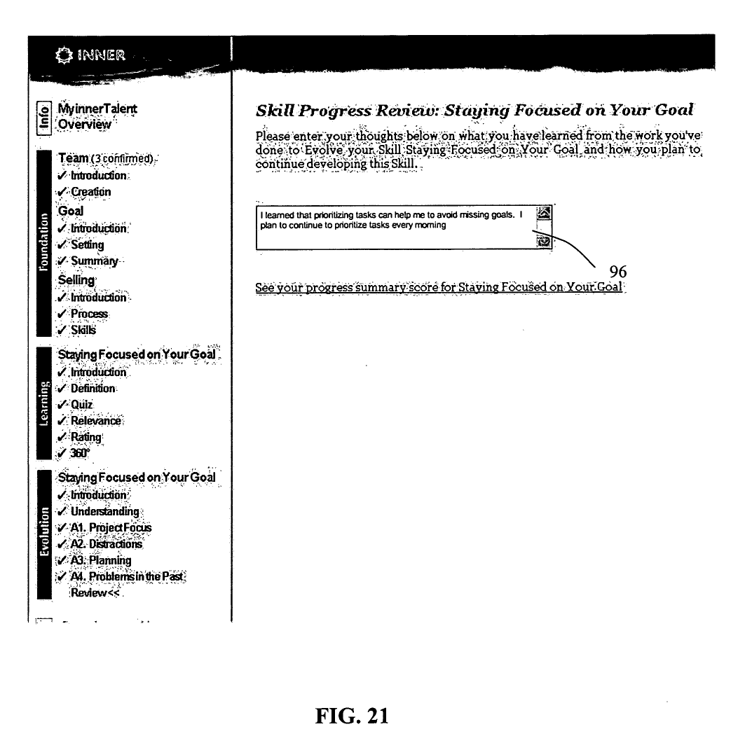

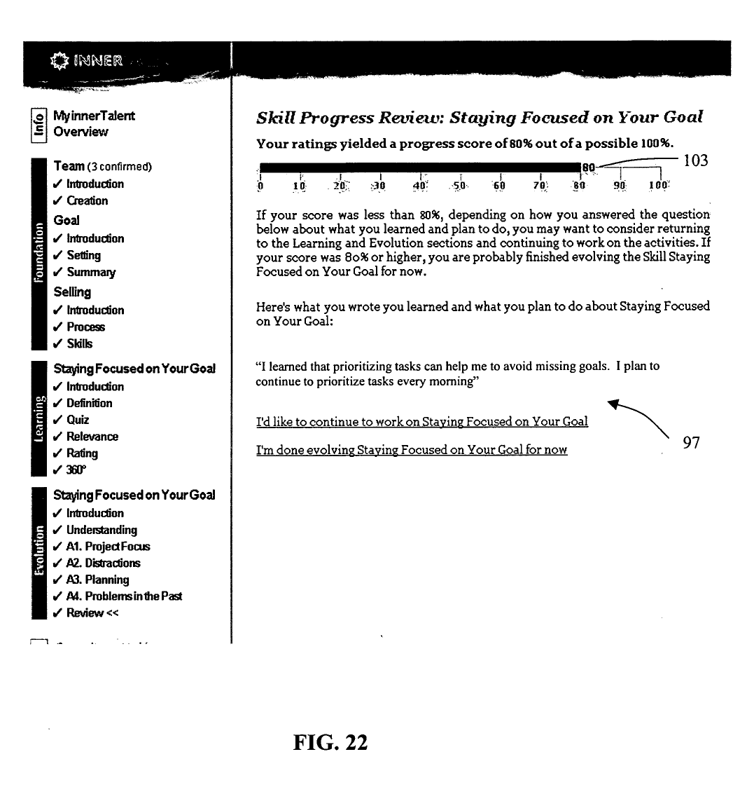

Screens used to provide a skill progress review are illustrated in FIGS. 20-22. The screen illustrated in FIG. 20 exemplifies a screen that may be used to display the personal experiences the user described earlier in the self-improvement process. The screen also may inquire whether the user feels they are prepared to handle the situation should it arise again. For example, the user may be requested to select an answer from a provided list 94 by selecting an answer selection box 95. The user also may be requested to enter their thoughts on what they have learned from the development process through an entry field 96 shown in FIG. 21. After the user has entered their thoughts, a skill progress score 103 may be displayed as shown in FIG. 22. The user may also be provided with options 97 that allow the user to decide whether to continue working on the goal or to continue on to another skill for development.

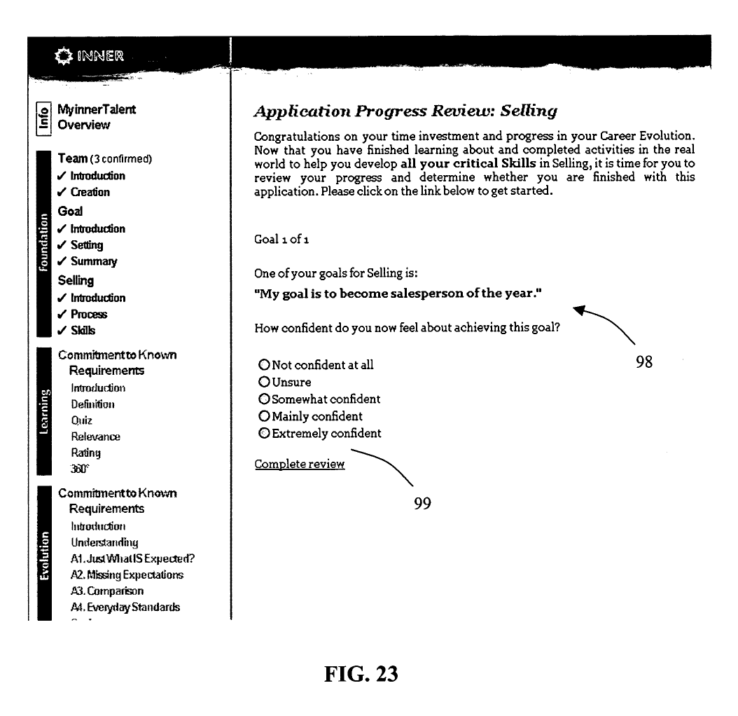

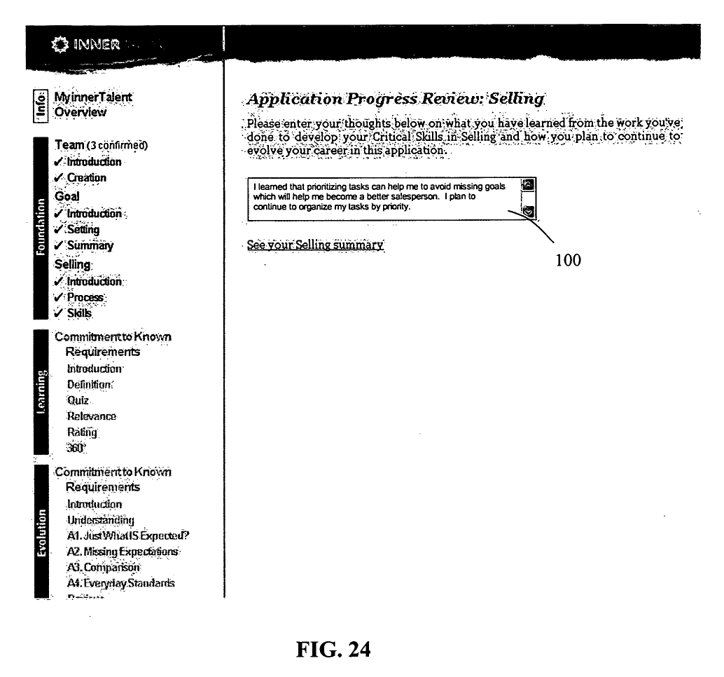

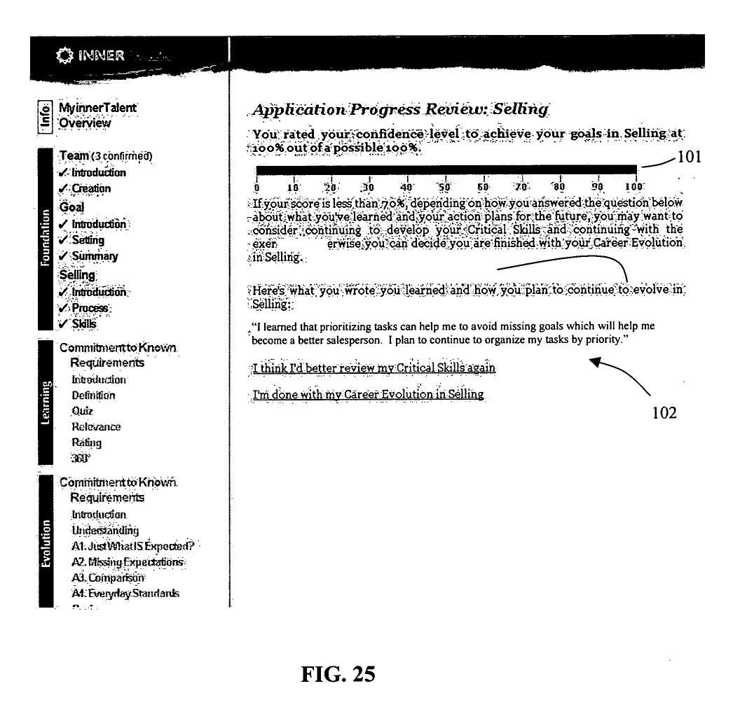

Finally upon completion of development of individual skills, the user is provided with a progress review addressing the development in the area of interest. Exemplary screens used to provide a progress review for the area of interest of selling are illustrated in FIGS. 23-25. The screen illustrated in FIG. 23 exemplifies a screen that may be used to display the goals that the user created during the self-improvement process. The screen also may inquire whether the user feels confident that they are capable of reaching the goal. For example, the user may be requested to select an answer from a provided list 98 by selecting an answer selection box 99. The user also may be requested to enter their thoughts on what they have learned from the development process through an entry field 100 shown in FIG. 24. After the user has entered their thoughts, a progress score 101 for the area of interest may be displayed as shown in FIG. 25. The user also may be provided with options 102 that allow the user to decide whether to continue working on the goal or to continue on to another skill for development.

While preferred illustrative embodiments of the invention are described above, it will be apparent to one skilled in the art that various changes and modifications may be made therein without departing from the invention. The appended claims are intended to cover all such changes and modifications that fall within the true spirit and scope of the invention.

What is claimed is:

1. A method of providing automated self-improvement coaching, comprising the steps of:
providing a computer system configured to execute a self-improvement program that includes a user repository database, a skills database that stores skill definition data, parameters for grouping skills into a plurality of areas of interest and scores for an archetypical high performer in the skills, a test module and a self-improvement coaching module;
requesting a user to take an axiological profile test offered by the test module;
storing profile test results in the user repository database;
determining the user's scores related to the skills grouped into the plurality of areas of interest through the self-improvement coaching module by combining data stored in the skills database and the user repository database;
providing a comparison of the user's skill scores with the scores of the archetypical high performers;
requesting the user to select a skill for development;
prompting the user to enter information in response to questions related to the skill;
storing the entered information in the user repository database;
providing the user with activities to develop the skill through the self-improvement coaching module; and
requesting the user to analyze information that the user entered related to the skill to determine progress in developing the skill.

2. The method of providing automated self-improvement coaching of claim 1, further comprising the steps of:
requesting a third party to provide an evaluation of the user's abilities related to a skill;
storing the third party evaluation results in the user repository database; and
presenting the third party evaluation results to the user.

3. The method of providing automated self-improvement coaching of claim 1, further comprising the steps of:
providing a quiz to test the user's knowledge of the skill;
storing quiz results in the user repository database; and
presenting the quiz results to the user.

4. The method of providing automated self-improvement coaching of claim 1, further comprising the steps of:
requesting the user to provide a self-evaluation of their abilities related to the skill; and
storing self-evaluation user input into the user repository database.

5. The method of providing automated self-improvement coaching of claim 1, further comprising the steps of:
determining a score correlating to the progress of the development of the skill; and
providing a review of the development progress related to the skill.

6. The method of providing automated self-improvement coaching of claim 1, further comprising the steps of:
requesting the user to select a second skill for development;
prompting the user to enter information related to the second skill;
storing the entered information in the user repository database;
providing the user with activities to develop the second skill through the self-improvement coaching module; and
requesting the user to analyze information that the user entered related to the skill.

7. The method of providing automated self-improvement coaching of claim 6, further comprising the step of providing a review of the development progress related to an area of interest that utilizes the first and second skills.

8. The method of providing automated self-improvement coaching of claim 1, further comprising the step of requesting the user to enter at least one personal experience related to the user's shortcomings in the skill.

9. The method of providing automated self-improvement coaching of claim 1, further comprising the step of requesting the user to enter at least one goal related to the skill.

10. The method of providing automated self-improvement coaching of claim 8, wherein the step of providing a review of the development progress related to the skill includes displaying the at least one personal experience related to the user's shortcomings in the skill and requesting the user to evaluate their ability handle the situation differently if it arose again.

11. The method of providing automated self-improvement coaching of claim 9, wherein the step of providing a review of the development progress related to the area of interest includes displaying the at least one goal related to the skill and requesting the user to evaluate their ability to meet the goal.

12. A self-improvement coaching system configured to be executed by a server and to interact with at least one user interface, comprising:
a user repository database;
a skills database that stores skill definition data, parameters for grouping skills into a plurality of areas of interest and skill scores for archetypical high performers;
a test module that is configured to provide the user with a test, through the user interface, wherein the test is configured to gather data regarding axiological characteristics of the user and to store the data in the user repository database; and
a self-improvement module that is configured to combine data stored in the user repository database and the skills database to provide the user with an assessment of skill proficiency and to provide a coaching process for improving skill deficiencies, wherein the self-improvement module interfaces with the user repository database to present the user with the user's input during the coaching process.

13. The self-improvement coaching system of claim 12, wherein the skills database stores skill scores for the archetypical high performer.

14. The self-improvement coaching system of claim 12, further comprising a user report module configured to provide a score report by combining data stored in the user repository database and the skills database.

15. The self-improvement coaching system of claim 12, wherein the user repository database is integrated into the server.

16. The self-improvement coaching system of claim 12, wherein the skills database is integrated into the server.

17. The self-improvement coaching system of claim 12, wherein the user repository database and the skills database are integrated into a single unit.

18. A method of providing automated self-improvement coaching, comprising the steps of:
providing a computer system configured to execute a self-improvement program that includes a user repository database, a skills database that stores skill definition data and parameters for grouping skills into a plurality of areas of interest, a test module and a self-improvement coaching module;
requesting a user to take an axiological profile test offered by the test module;
storing the profile test results in the user repository database;
determining the user's scores related to the skills by combining data stored in the skills database and the user repository database;
requesting the user to select a skill for development;
providing the user with a test related to the skill configured to test the user's knowledge of the skill;
prompting the user to provide a self-evaluation of their skill ability;
providing third-party evaluations of the user's skill ability;
storing the test, self-evaluation and third-party information in the user repository database;
providing the user with a comparison of the test, self-evaluation and third party information;
providing the user with activities to develop the skill through the self-improvement coaching module; and
requesting the user to analyze information that the user entered related to the skill.

19. The method of providing automated self-improvement coaching of claim 8, further comprising the step of requesting the user to enter at least one personal experience related to the user's shortcomings in the skill.

20. The method of providing automated self-improvement coaching of claim 8, further comprising the step of requesting the user to enter at least one goal related to the skill.
